(19) United States
(12) Patent Application Publication
(10) Pub. No.: US 2007/0242570 A1
(43) Pub. Date: Oct. 18, 2007

(54) Alarm information display unit

(75) Inventor: Takashi Sato, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 11/730,798

(22) Filed: Apr. 4, 2007

(30) Foreign Application Priority Data
Apr. 7, 2006 (JP) 2006-105794

(51) Int. Cl. G11B 7/085; G11B 21/08; G08B 29/00

(52) U.S. Cl. 369/30.21; 340/506

(57) ABSTRACT

There is realized an alarm information display unit capable of enabling a message relating to an error of a hardware placed in a predetermined managing environment to be displayed on a display screen together with normal alarm information. In the alarm information display unit for collecting alarm information from external equipment and displaying it on a display screen of a monitoring means, and mounting thereon a hardware placed in a predetermined managing environment, the alarm information display unit comprises an error retrieval means for retrieving newly occurred error while gaining access to a system log in which error information of the hardware is written, an error message generation means for generating an error message relating to the error information detected when retrieved by the error retrieval means, and a display control means for causing the generated error message to be displayed on the display screen together with the alarm information.

### FIELD OF THE INVENTION

The invention relates to an alarm information display unit for collecting alarm information from outer equipment and displaying it on a display screen of a monitoring means while mounting thereon a hardware placed in a predetermined environment.

### BACKGROUND OF THE INVENTION

There is available a decentralized control system provided with an operation monitoring unit for collecting and displaying alarm information of equipment operating in a plant. FIG. 4 is a functional block diagram showing an example of a configuration of a decentralized control system provided with a conventional operation monitoring unit for mounting thereon a hardware which is placed in a predetermined managing environment.

Depicted by 1 is an operation monitoring unit 1 which is connected to a control bus 2. Depicted by 3 is a controller connected also to the control bus 2. The controller 3 communicates with the operation monitoring unit 1, and also communicates with equipment 51, 52, . . . 5n of a plant 5 via a field bus 4 to thereby control them. The operation monitoring unit 1 collects alarm information AL generated in the equipment 51, 52, . . . n of the plant 5 via the controller 3.

In the operation monitoring unit 1, depicted by 11 is a CPU for gaining access to a memory 13 via an internal bus 12. Depicted by 14 is an alarm information processing means for collecting the alarm information AL to be noticed from the controller 3 and causing the collected alarm information AL to be held in a hard disk which was placed in a predetermined managing environment, described later, or extracts the alarm information AL held in the hard disk for displaying purpose.

Depicted by 15 is an alarm display editing means for editing a display format of the extracted alarm information and delivering it to a display control means 16. The display control means 16 displays the delivered alarm information in a predetermined format on an alarm information display area 18a of a display screen 18 of a monitoring means 17 such as a monitor and so forth.

Depicted by 20 is a predetermined managing environment, and in this embodiment, it is a multiplexing environment of a disk complying with a RAID (Redundant Array of Inexpensive Disks)-1 standards. The RAID-1 provides a mirroring environment for writing the same data in two hard disks at the same time and handles two hard disks logically as one disk.

Depicted by 21 and 22 are two hard disks which were duplex and managed by the RAID-1, wherein the same data is written in the two hard disks 21 and 22 at the same time by a RAID 1 driver 23 connected to the internal bus 12, namely, the mirroring is executed. The hard disks may be multiplex for triplex abnormalities thereof.

Depicted by 24 is an error monitoring means. When the error monitoring means 24 acquires notice of error from the RAID-1 driver 23 in the case where there occurs an error, for example, in the disk 21 of two hard disks, it writes error information in a system log 25 of an operating system (hereinafter referred to as OS) which is held in a normal hard disk 22, and outputs an error display command R to the display control means 16.

It is a specification of the error display command R to cause a RAID error display icon 19 arranged on a task bar tray 18b located at the lower portion of the display screen 18 to be displayed while changed in color (green to red), and to display a tooltip message.

FIG. 5 is an image view of a tooltip message 19a. The displayed tooltip message is automatically erased by an operator when he or she operates an erasing button placed on a right top of the screen (not shown), or upon elapse of a given time.

Although the RAID-1 environment has been progressively supported on a general mother board as standard owing to a rapid development of a PC technology and price reduction of the PC, the function thereof is managed by a driver and an application software which have been provided by a hardware vender, and hence it is difficult for a purchaser to customize the specification thereof.

In JP 2005-228027 A, there is descried an alarm display unit for displaying a message noticed from a plant on a screen when an alarm is generated.

However, a conventional RAID-1 error display specification has had the following problems.

(1) Although the error display by an icon and the notice by a tooltip are implemented on the task bar tray, they are not noticed on the alarm information display area 18a which is monitored attentively by an operator in the same manner as a normal system alarm.

(2) Since the task bar is hidden in the operation monitoring unit in a normal usage pattern, if a tooltip display is erased, abnormalities can not be recognized. Even if the task bar is seen, there is a possibility of overlooking the abnormalities because the display within the task bar tray is small.

(3) Since there is a case where even the notice of occurrence of an error is not made on the screen depending on the specification provided by the hardware vender, there is a high possibility that an operator overlooks important abnormalities relating the hard disk.

(4) An important error notice around the hardware depends on a display function (display system, stability, reliability, and so forth) of the error notice based on a program specification provided by the hardware vender who monitors RAID conditions, and it is not unified in a standard alarm display specification provided in a user system, thereby providing a display environment of different quality.

### SUMMARY OF THE INVENTION

The invention has been developed in order to resolve the problems described as above, and it is an object of the invention to realize an alarm information display unit capable of enabling a message relating to an error of a hardware placed in a predetermined managing environment to be displayed on a display screen together with normal alarm information.

To that end, the invention has the following configuration.

(1) In an alarm information display unit for collecting alarm information from external equipment and displaying it on a display screen of a monitoring means, and mounting thereon a hardware placed in a predetermined managing environment, it is characterized in comprising:

an error retrieval means for retrieving newly occurred error while gaining access to a system log in which error information of the hardware is written;

an error message generation means for generating an error message relating to the error information detected when retrieved by the error retrieval means; and

a display control means for causing the generated error message to be displayed on the display screen together with the alarm information.

(2) The alarm information display unit as set forth under item (1) as above is characterized in that the hardware is a multiplex hard disk.

(3) The alarm information display unit as set forth under item (2) as above is characterized in that the managing environment manages the two hard disks in compliance with a RAID-1 standards.

(4) The alarm information display unit as set forth under item (2) or (3) as above is characterized in that an error monitoring means provided in the managing environment writes the error information in the system log in the case where there occurs an error in one of two hard disks.

(5) The alarm information display unit as set forth under any of items (1) to (4) as above is characterized in that the error retrieval means generates a retrieval target information file for holding at least any of an alarm source name, an error number, a latest error time, a notice message when detecting newly occurred error upon retrieval of the system log.

(6) The alarm information display unit as set forth under item (5) as above is characterized in that the latest error time is an error record time matching both the alarm source name and the error number.

As is evident from the foregoing explanation, the invention has the following advantageous effects:

(1) Since the occurrence of an error can be displayed on the alarm information display area which is monitored attentively by an operator, without changing a conventional environment under which the error display by the icon and the notice by the tooltip are implemented on the task bar tray, there seldom occurs a possibility that the operator overlooks important abnormalities relating to the hard disk.

(2) Since the occurrence of an error can be displayed on the alarm information display area of the screen, even if the tooltip display can not be confirmed because the task bar is hidden in a normal usage pattern of the operation monitoring device, there seldom occurs a possibility that an operator overlooks important abnormalities relating to the hard disk.

(3) Since the occurrence of an error can be displayed on the alarm information display area of the screen, even if the occurrence of the error is not noticed on the screen according to the specification provided by the hardware vender, there seldom occurs a possibility that an operator overlooks important abnormalities relating to the hard disk.

(4) The important error notice around the hardware can be easily unified in a standard alarm display specification provided in a user system without resorting to the display function (display system, stability, reliability, and so forth) of the error notice based on a program specification provided by the hardware vender who monitors RAID conditions.

### BRIEF DESCRIPTION OF THE DRAWINGS

FIG. 1 is a functional block diagram showing a sample of a configuration of a decentralized control system provided with an operation monitoring unit to which the invention is applied;

FIG. 2 is a functional block diagram showing a software architecture of a relevant portion of the invention;

FIG. 3 is a flowchart showing a signal processing procedure of the invention;

FIG. 4 is a functional block diagram showing a sample of a configuration of a decentralized control system provided with a conventional operation monitoring unit for mounting thereon a hardware placed in a predetermined managing environment; and

FIG. 5 is an image view of a tooltip message.

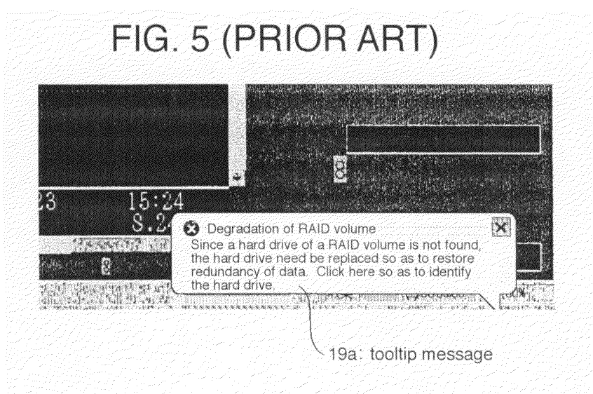

### PREFERRED EMBODIMENTS OF THE INVENTION

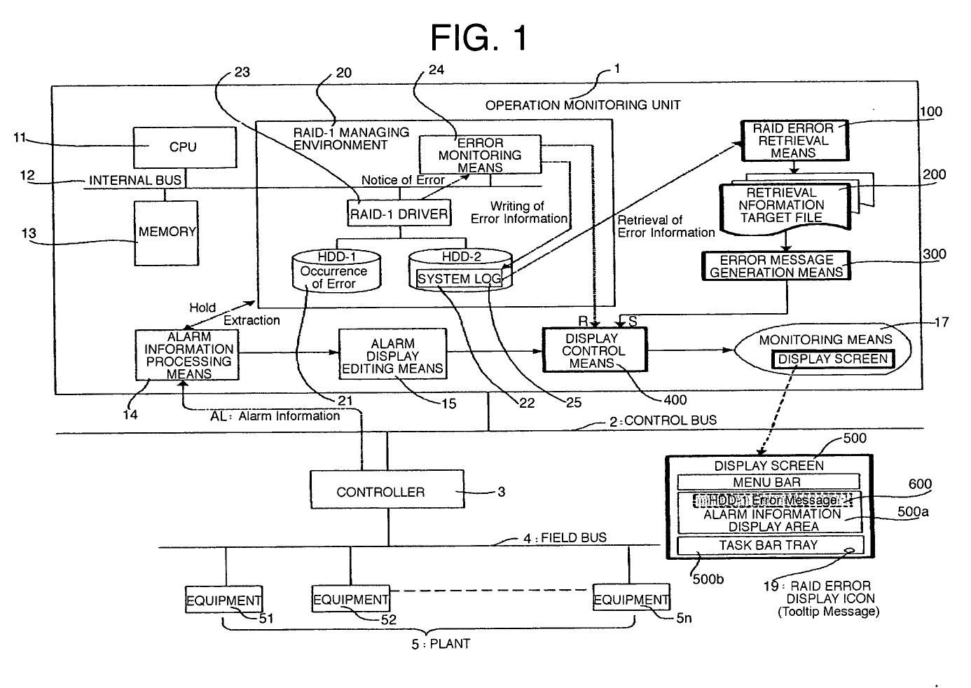

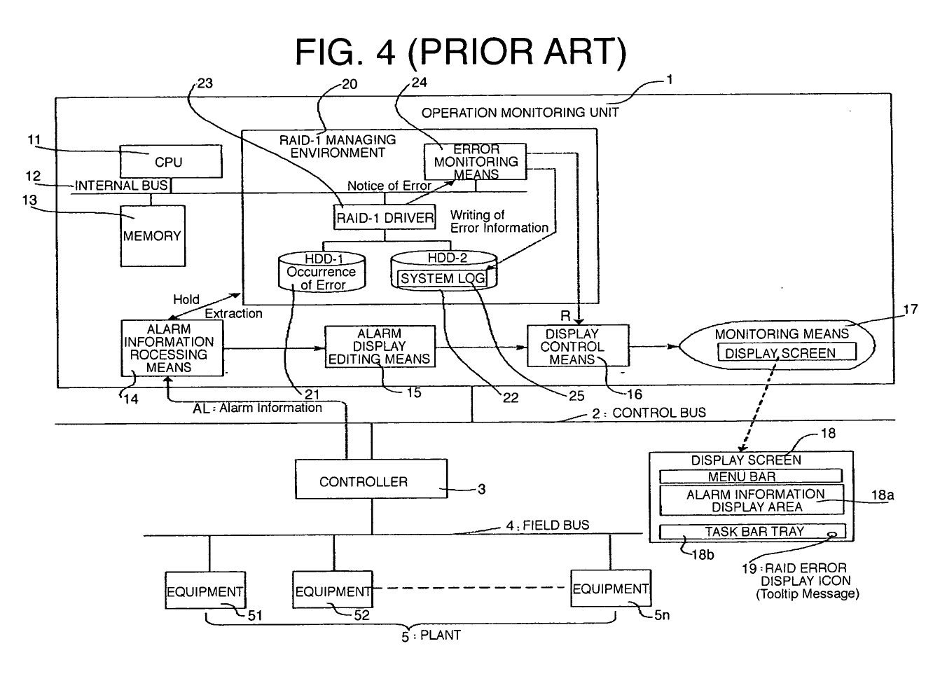

The invention is described in detail hereafter with reference to the attached drawings. FIG. 1 is a functional block diagram showing a sample of a configuration of a decentralized control system provided with an operation monitoring unit to which the invention is applied. In the figure, constituent elements identical to those in the conventional system as described with reference to FIG. 4 are depicted by the same reference numerals, thereby omitting description thereof. Features of the invention are described hereinafter.

In an operation monitoring unit 1, depicted by 100 is a RAID error retrieval means which gains access to a system log 25 which is held in a hard disk 22 in which error information of a hard disk 21 is written, and retrieves newly occurred error.

A retrieval target information file 200 holds at least any of an alarm source name, an error number, a latest error time, a notice message. When a newly occurred error is detected when retrieved by the RAID error retrieval means 100 while gaining access to the system log 25, the content of the retrieval target information file 200 is rewritten.

Depicted by 300 is an error message generation means which refers to the retrieval target information file 200, and generates an error message S relating to the detected error information so as to be noticed to an operator, then delivered to a display control means 400.

The display control means 400 has a function, in addition to the function of the conventional display control means 16 as explained in FIG. 4, to acquire the error message S from the error message generation means 300, to cause this error message S to be displayed on an alarm information display area 500a of a display screen 500 of a monitoring means 17 together with normal alarm information.

Depicted by 600 is an example of an alarm (error) message displayed on the display area 500a of the display screen 500. A RAID error display icon 19 and a tooltip message are displayed on a task bar tray 500b located at the lower portion of the display screen 500 in the same manner as the conventional unit.

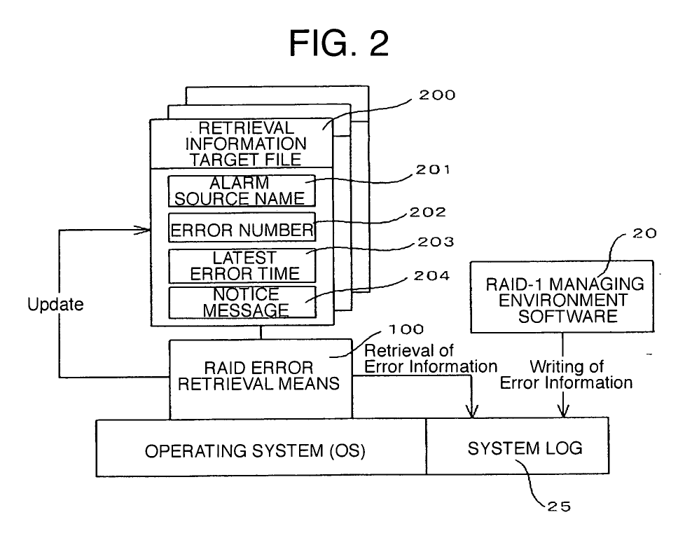

FIG. 2 is a functional block diagram showing a software architecture of a relevant portion of the invention. The system log 25 is a part of a standard function of an operating system (hereinafter referred to as OS), in which the error information of a hard disk is written by a software of a RAID-1 managing environment 20.

The RAID error retrieval means 100 operating on the OS gains access to the system log 25 to monitor a newly occurred error, and if it detects the newly occurred error when retrieved, it updates the content of information held in the retrieval target information file 200.

Information held in the retrieval target information file 200 is held even if a power supply of the operation monitoring unit 1 is turned off. Further, the retrieval target information file 200 has multiple file structures to cope with managing environment software of multiple hardware venders.

The content of information held in the retrieval target information file 200 comprises an alarm source name 201, an error number 202, a latest error time 203, and a notice message 204.

The alarm source name 201 is a unique name (character string) given by a vender so as to identify a vender soft for monitoring the RAID conditions on the system log 25. The error number 202 is a number for specifying a relevant error such as troubles and so forth of one of hard disks.

The latest error time 203 is a time of a latest error record which matches both the alarm source name 201 and the error number 202. As an initial value, there is set a value (old time such as 1970/Jan./10 00:00 and so forth) meaning “non-finding” of a relevant error code.

The notice message 204 is the content of a system alarm message which is noticed to an operator when the relevant error is detected. The content of this message is edited to an error message 600 by the error message generation means 300 so as to be noticed to the operator, and displayed on the display screen 500, but there is a case where the notice message 204 is displayed on the display screen 500 as it is.

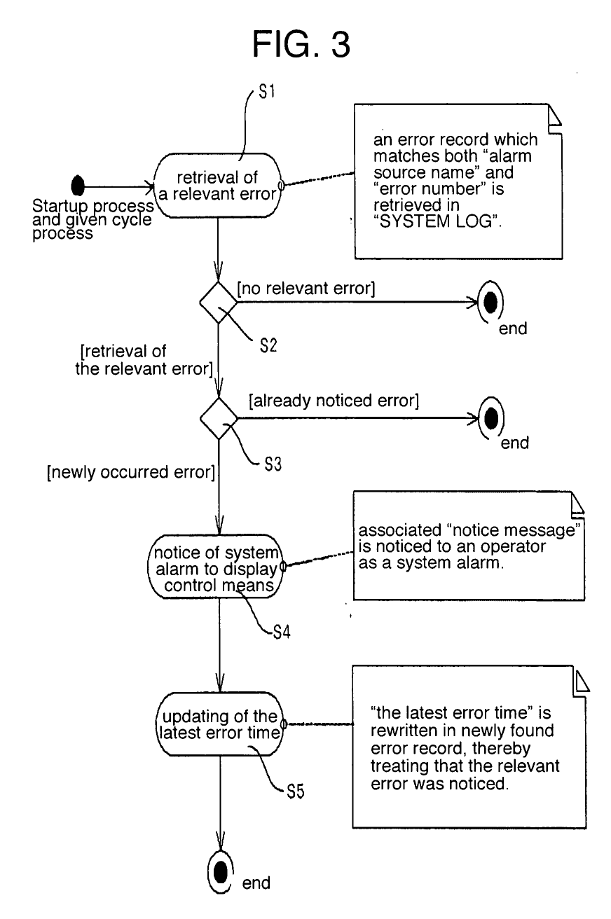

FIG. 3 is a flowchart showing a signal processing procedure of the invention. In Step 1 where a startup process and a given cycle (e.g. 10 minutes) process of the operation monitoring device are implemented, the RAID error retrieval means 100 retrieves an error record matching both the alarm source name and the error number in the system log 25. If there are multiple error records, the PADI error retrieval means 100 retrieves the latest error record.

In Step S2, if the relevant error is detected when retrieved by the RAID error retrieval means 100, it is compared with the latest error time in Step S3, and if the relevant error is later, the operation proceeds to Step S4 as a newly occurred error. In Step S4, an associated notice message is noticed to the operator as a system alarm, and the operation proceeds to Step S5.

In Step S5, the latest error time is updated to a time of newly found error record for treating it that the relevant error was noticed, thereby completing the given cycle process.

Meanwhile, in the actual retrieval of the given cycle, it is optimized so as to retrieve only an event which generated after the previous retrieval because there are many phenomena such as an error, warning, notice, and so force as an event to be entered in the system log.

In the embodiment as set forth above, although there is exemplified the screen display of the error information of the hard disk placed in the RAID-1 managing environment, the invention is not limited to this example, and it can be generally applied to a managing environment where an error remains in the system log of the OS.

It is possible to notice an alarm and guidance information to an operator by monitoring a cooling environment of a CPU, and a temperature inside a housing of a PC, for example, by monitoring the number of revolutions or rotating conditions of a plurality of fans, or by use of a S.M.A.R.T. (Self Monitoring Analysis and Reporting Technology) for managing the temperature of a HDD (Hard Disk Drive), and so forth.

1. An alarm information display unit for collecting alarm information from external equipment and displaying it on a display screen of a monitoring means, and mounting thereon a hardware placed in a predetermined managing environment, said alarm information display unit comprising:
an error retrieval means for retrieving newly occurred error while gaining access to a system log in which error information of the hardware is written;
an error message generation means for generating an error message relating to the error information detected when retrieved by the error retrieval means; and
a display control means for causing the generated error message to be displayed on the display screen together with the alarm information.

2. The alarm information display unit according to claim 1, wherein the hardware is a multiplex hard disk.

3. The alarm information display unit according to claim 2, wherein the managing environment manages the two hard disks in compliance with a RAID-1 standards.

4. The alarm information display unit according to claim 2 or 3, wherein an error monitoring means provided in the managing environment writes the error information in the system log in the case where there occurs an error in one of two hard disks.

5. The alarm information display unit according to any of claims 1 to 3, wherein the error retrieval means generates a retrieval target information file for holding at least any of an alarm source name, an error number, a latest error time, a notice message when detecting newly occurred error upon retrieval of the system log.

6. The alarm information display unit according to claim 5, wherein the latest error time is an error record time matching both the alarm source name and the error number.
